(19) United States
(12) Patent Application Publication
(10) Pub. No.: US 2024/0322114 A1
(43) Pub. Date: Sep. 26, 2024

(54) PROCESS ARRANGEMENT AND METHOD FOR PRODUCING AN ELECTRODE

(71) Applicant: Volkswagen Aktiengesellschaft, Wolfsburg (DE)

(72) Inventors: Ludger BUSSWINKEL, Braunschweig (DE); Sven SCHOPF, Braunschweig (DE); Roland SCHMIDT-LOBACH, Hoersingen (DE); Sebastian REUBER, Dresden (DE)

(73) Assignee: Volkswagen Aktiengesellschaft, Wolfsburg (DE)

(21) Appl. No.: 18/612,871

(22) Filed: Mar. 21, 2024

(30) Foreign Application Priority Data
Mar. 21, 2023 (DE) 10 2023 202 484.5

(51) Int. Cl. H01M 4/04

(52) U.S. Cl. CPC H01M 4/0435; H01M 4/0416

(57) ABSTRACT

A process arrangement for producing an electrode of a battery cell using dry forming, with a film forming/laminating process in which an electrode active material in the form of a solvent-free dry film powder can be laminated onto one or both sides of a substrate as a dry film, forming the electrode. The film forming/laminating process is followed by a compression process, in which the dry film laminated to the substrate can be compressed to a target density.

This nonprovisional application claims priority under 35 U.S.C. § 119(a) to German Patent Application No. 10 2023 202 484.5, which was filed in Germany on Mar. 21, 2023, and which is herein incorporated by reference.

### BACKGROUND OF THE INVENTION

### Field of the Invention

The invention relates to a process arrangement for producing an electrode of a battery cell and a method for producing such an electrode.

### Description of the Background Art

In producing an electrode, an electrode active material mixed with a solvent is usually coated in a viscous form on a substrate in a wet coating. The substrate coated with the electrode active material is then dried in a drying process to evaporate the solvent from the active material.

Instead of using such a wet coating, the electrode is produced by dry forming in accordance with the generic method, namely using a film-forming/laminating process in which the electrode active material is laminated as a solvent-free dry film powder to the substrate as a dry film on one or both sides.

Such a method is known from WO 2018/210723 A1, which corresponds to US 2021/0320288. Accordingly, in order to carry out the film forming/laminating process, at least one pair of calender rollers is provided, the calender rollers of which are spaced apart by a film forming/roller gap. The dry film powder is filled into a roller gap feed section. In the film forming roller gap, the dry film powder is compressed into a dry film under pressure, heat and shear. The dry film adheres to the output of the film forming roller gap as a roller-borne dry film on one of the calender rollers. The calender roller, which carries the dry film, forms a laminating roller gap with a counterpressure roller, through which the substrate runs. In the laminating roller gap, the dry film adhering to the calender roller is coated onto the substrate.

In order for the dry film coated on the substrate to achieve a predefined target density, in the prior art, the calender roller carrying the dry film and the counterpressure roller must press against each other with sufficient pressure. However, it has been shown that excessive roller pressure can lead to damage to the dry film or the current collector film/substrate. In addition, a springback effect can occur in the dry film after it runs through the laminating roller gap, particularly at high target densities, in which the dry film coated on the substrate springs back after leaving the laminating roller gap.

Further methods for producing an electrode using dry forming are known from US 2016/0181651 A1, US 2022/0293952 A1 and DE 10 2021 102 223 A1.

### SUMMARY OF THE INVENTION

It is therefore an object of the invention to provide a method and a process arrangement for producing an electrode of a battery cell using dry forming, in which a predefined target density of the dry film laminated onto the substrate can be achieved in a process-safe and simple manner as compared to the conventional art.

The invention is based on a process arrangement for producing an electrode of a battery cell using dry forming. The process arrangement has a film forming/laminating process in which an electrode active material is laminated onto a substrate as a dry film as a solvent-free dry film powder onto one or both sides, forming the electrode. According to the characterizing part of claim 1, the film forming/laminating process is followed by a compression process in which the dry film laminated onto the substrate is compressed to a target density. According to the invention, a separate post-compression takes place after the film forming/laminating process, so that an excessively high roller pressure in the film forming/laminating process can be dispensed with. Due to the two-stage compression according to the invention, the predefined target density in the dry film can be set with high process accuracy.

The substrate can be fed into the film forming/laminating process in the form of an endless web. Accordingly, the electrode can be formed in the film forming/laminating process in the form of an endless web. To carry out the compression process, at least one pair of compressor rollers can be provided, through whose roller gap the electrode runs. The two compressor rollers of the pair of rollers can press against each other in the roller gap with a predefined compressive force in order to compress the dry film to the target density.

The film forming/laminating process may take place in a calendering system, through which the substrate is continuously conveyed as an endless web. The calendering system can have a rewinding unit on the output side, in which the formed electrode is wound onto a coil. The electrode coil can be transferred to a compression unit, in which the electrode is first unwound in an unwinding unit and then fed into the compression process.

It can also be preferable in terms of production technology if the compression process takes place immediately downstream of the film forming/laminating process. In this case, the compression process can preferably be carried out directly in the calendering system, without the need for a separate compression unit, which reduces the production effort. In this case, the electrode formed in the film forming/laminating process can be fed directly into the compression process without interruption, i.e., without additional winding onto a coil or unwinding from a coil.

In order to ensure proper solidification of the dry film, it is preferable if the film forming/laminating process as well as the compression process can be carried out under the influence of heat. In this case, for example, the calender rollers provided for the film forming/laminating process can be heated up to a process temperature of, for example, 80° C. to 150° C. In terms of production technology, it is advantageous if the electrode is fed into the compression process while still in a hot state, after the film forming/laminating process has been completed. In this way, the compression process can be carried out using the thermal energy that was absorbed by the electrode in the film forming/laminating process. The provision of an additional heating device in the compression process can therefore be avoided.

To carry out the film forming/laminating process, at least one pair of calender rollers can be provided, the calender rollers of which are spaced apart by a film forming roller gap. The dry film powder can be filled into a roller gap feed section and compressed into a dry film in the film forming roller gap under pressure, heat and shear. This is then laminated onto the substrate.

Due to its low layer thickness, the dry film has only reduced mechanical stability. For this reason, it is preferable for proper dry film formation if the dry film is not conveyed as a free-standing film from the roller gap output of the film forming roller gap, but instead if the dry film at the roller gap output adheres to one of the calender rollers as a roller-borne dry film. The calender roller carrying the dry film, together with a counterpressure roller, can form a laminating roller gap through which the substrate runs. In the laminating roller gap, the dry film supported by the calender roller is coated onto the substrate.

A pair of calender rollers can be arranged on both sides mirror-symmetrically with respect to the substrate plane. In this case, the calender roller located on the opposite side of the substrate can also act as a counterpressure roller in double function. A separate provision of a counterpressure roller can therefore be avoided.

In order to ensure damage-free post-compression of the dry film, the compressor rollers provided for the compression process may be larger in diameter than the calender rollers provided for the film forming/laminating process.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 to 3 different process arrangements for producing an electrode.

### DETAILED DESCRIPTION

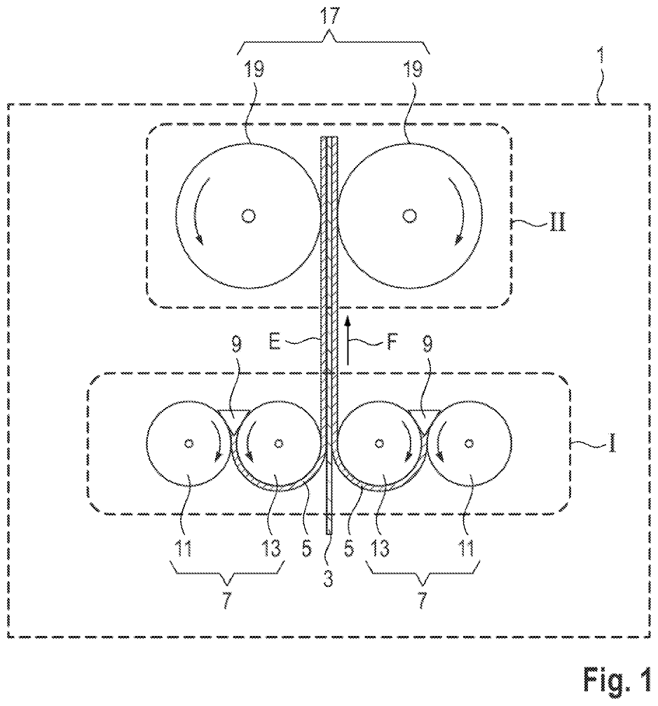

FIG. 1 shows a process arrangement according to an example, in which an electrode E is produced by dry forming in the form of an endless web. The process arrangement has a calendering system 1, through which a substrate 3 in the form of an endless web is continuously guided in a production direction F to form the electrode E. In the electrode E, the electrode active material is laminated onto both sides of the substrate 3 as dry film 5 with a predefined target density. The calendering system 1 performs a film forming/laminating process I in a first method step, while a compression process II is carried out immediately afterwards in a second method step.

To carry out the film forming/laminating process I, the calendering system 1 in FIG. 1 has a pair of calender rollers 7 on both sides of the substrate 3. The two pairs of calender rollers 7 are mirror images with respect to the substrate plane. In each pair of calender rollers, the calender rollers 11, 13 are spaced from each other via a film forming roller gap. The roller gap feed section is filled with a solvent-free dry film powder 9, while the two calender rollers 11, 13 rotate counterclockwise to each other to feed the dry film powder 9 into the film forming roller gap. The calender roller 13 close to the substrate rotates faster than the calender roller 11 remote from the substrate 3, which supports the adhesion of the dry film 5 to the calender roller 13 close to the substrate.

In the film forming roller gap, the dry film powder 9 is compressed under pressure, heat and shear to form a dry film 15. In order to ensure perfect solidification of the dry film 5, the two calender rollers 11, 13 can be heated, for example up to temperatures in the range of 80° C. to 120° C. With regard to further process characteristics of the film forming/laminating process I described in FIG. 1, reference is made to WO 2018/210723 A1, in which the film forming/laminating process is explained in detail.

In FIG. 1, the calender roller 13 that carries the dry film 5 and is close to the substrate, together with the calender roller 13 that is mirrored opposite with respect to the substrate plane, forms a laminating roller gap through which the substrate 3 runs. In the laminating roller gap, the dry film 15 that is carried by the calender roller 13 close to the substrate is coated onto the substrate 3 and pre-compressed.

In FIG. 1, the electrode E, which is pre-compressed in the laminating roller gap, is fed into the compression process II while still hot, in which it is re-compressed to the target density. To carry out the compression step II, a pair of rollers 17 is provided in FIG. 1, through whose roller gap the electrode E runs. The two compressor rollers 19 of the roller pair 17 press against each other with a predefined compressive force with the electrode E in between.

It is of particular importance that the electrode E is transferred directly to the compression process II in the hot state. As a result, the compression process II can be carried out using the thermal energy E absorbed by the electrode E in the film forming/laminating process I.

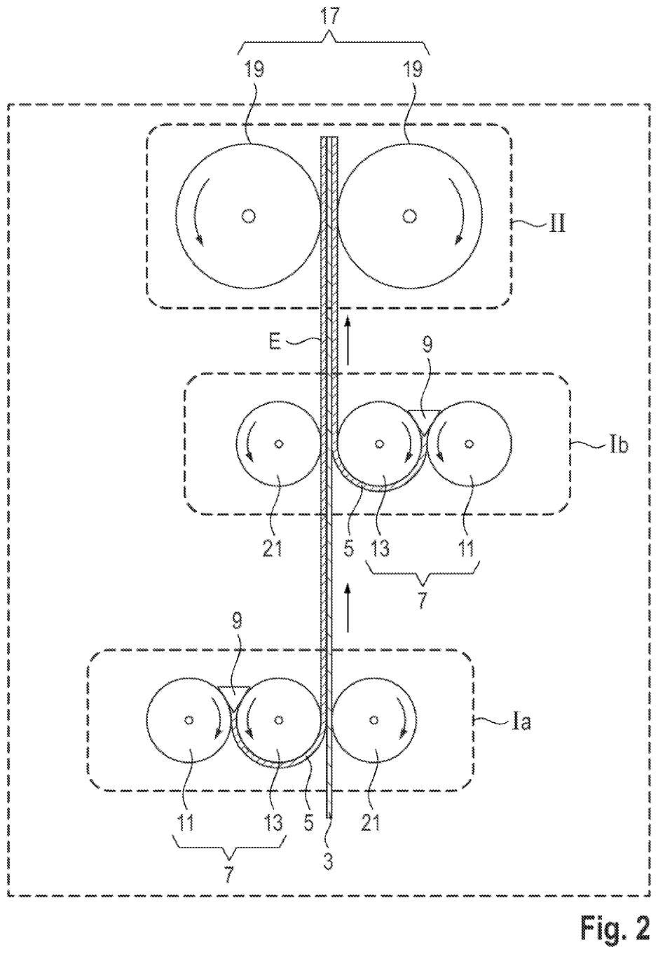

FIG. 2 shows a process arrangement according to an example. The structure and functioning of the calendering arrangement shown in FIG. 2 essentially corresponds to the structure and mode of action of the calendering system 1 shown in FIG. 1, so that reference is made to its preliminary description. In contrast to FIG. 1, in FIG. 2 the pairs of calender rollers 7 of the film forming/laminating process I, which are arranged on both sides of the substrate 3, are not mirror images, but rather arranged one behind the other at a distance in the production direction F. In FIG. 2, the left side of the substrate 3 is first coated with a dry film 5 with the help of the pair of calender rollers 7 arranged on the left in FIG. 2. For this purpose, the calender roller 13, which carries the dry film 5, interacts with a counterpressure roller 21 arranged on the opposite (i.e., right) side of the substrate (i.e., process stage Ia in FIG. 2). The laminating roller gap is formed between the calender roller 13 and the counterpressure roller 21. In the further course of the process, the right side of the substrate 3 is coated with another dry film 5 (i.e., process stage Ib in FIG. 2). For this purpose, the calender roller 13, which carries the further dry film 5, interacts with a counterpressure roller 21 arranged on the opposite (i.e., left) side of the substrate, which also forms a laminating roller gap with the calender roller 13.

After completion of the film forming/laminating process I, the electrode E, which is coated onto both sides, is fed into the compression process II, which is identical to that described in FIG. 1.

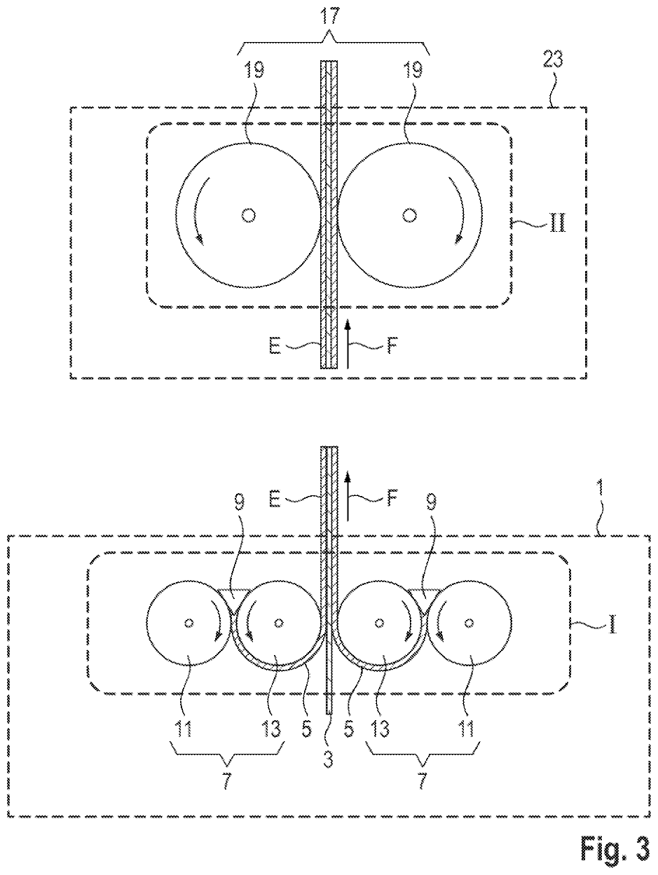

FIG. 3 shows a process arrangement according to an example. Its structure and functioning are essentially the same as the structure and functioning according to FIG. 1. In contrast to FIG. 1, in FIG. 3 the process arrangement has a calendering system 1 and, separately, a compression unit 23. Analogous to FIG. 1, a film forming/laminating process I takes place in the calendering system 1. After completion of the film forming/laminating process I, the electrode E is wound onto a coil in a rewinding unit, not shown, of the calendering system 1. The electrode coil is then transferred to the compression unit 23. In the compression unit 23, the electrode coil is unwound in an unwinding unit and subjected to the compression process II.

In FIG. 3, therefore, the film forming/laminating process I and the compression process II can be carried out in separate systems 1, 23. Accordingly, additional system components, such as rewinding units, unwinding units and an additional roller heating device for the compression unit 23, are required for electrode handling in order to heat the two compressor rollers 19 during post-compression.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A process arrangement to produce an electrode of a battery cell using dry forming, comprising a film forming/laminating process in which an electrode active material in the form of a solvent-free dry film powder is laminated onto one or both sides of a substrate forming the electrode, wherein the film forming/laminating process is followed by a compression process in which the dry film laminated onto the substrate is compressed to a target density.

2. The process arrangement according to claim 1, wherein the electrode is formed as an endless web in the film forming/laminating process and/or wherein at least one pair of compressor rollers, through whose roller gap the electrode runs, is provided to carry out the compression process) and wherein the two compressor rollers of the roller pair are pressed against each other in the roller gap with a predefined compressive force.

3. The process arrangement according to claim 1, wherein the film forming/laminating process takes place in a calendering system and wherein the calendering system has a winding unit in which the formed electrode is wound onto a coil, and wherein the coiled electrode coil is transferred to a compression unit in which the electrode is fed into the compression process.

4. The process arrangement according to claim 1, wherein the compression process is immediately downstream of the film forming/laminating process, and/or wherein the compression process takes place directly in the calendering system, and/or wherein the electrode is fed directly into the compression process immediately after the film forming/laminating process without interruption or without winding onto a coil or unwinding from a coil.

5. The process arrangement according to claim 1, wherein the film forming/laminating process and/or the compression process is carried out under the influence of heat, and/or wherein the electrode is fed into the compression process in the hot state after the film forming/laminating process has taken place so that the compression process is carried out using the thermal energy absorbed by the electrode in the film forming/laminating process.

6. The process arrangement according to claim 1, wherein at least one pair of calender rollers is provided for carrying out the film-forming/laminating process, the rollers of which are spaced from each other by a film forming roller gap, wherein the dry film powder is filled into a feed section of the film-forming roller gap and compressed into the dry film in the film forming roller gap under pressure, heat and shear, and wherein the dry film is laminated onto the substrate.

7. The process arrangement according to claim 6, wherein the dry film adheres to one of the calender rollers as a roller-borne dry film, that the calender roller supporting the dry film forms a laminating roller gap with a counterpressure roller through which the substrate runs, and wherein the dry film adhering to the calender roller is coated onto the substrate in the laminating roller gap.

8. The process arrangement according to claim 7, wherein, with respect to the substrate plane, a pair of calender rollers s arranged on both sides, and wherein the two pairs of calender rollers are arranged mirror-symmetrically with respect to the substrate plane, so that the calender roller located on the opposite side of the substrate acts as a counterpressure roller in double function.

9. The process arrangement according to claim 2, wherein the rollers provided for the compression process are larger in diameter than the calender rollers provided for the film forming/laminating process.

10. A method for producing an electrode of a battery cell using dry forming in the process arrangement according to claim 1, the method comprising:
Laminating, in a film forming/laminating process, an electrode active material in the form of a solvent-free dry film powder as a dry film onto one or both sides of a substrate;
forming the electrode; and
compressing, after the film forming/laminating process in a compression process, the dry film laminated to the substrate to a target density.
